(19) United States
(12) Patent Application Publication
(10) Pub. No.: US 2013/0054585 A1
(43) Pub. Date: Feb. 28, 2013

(54) GEOGRAPHIC SEARCH WITH MIXED-PRECISION RESULTS

(71) Applicants: Daniel James Driscoll, Bellevue, WA (US); Christina Ashley Maertens, Redmond, WA (US)

(72) Inventors: Daniel James Driscoll, Bellevue, WA (US); Christina Ashley Maertens, Redmond, WA (US)

(73) Assignee: Microsoft Corporation, Redmond, WA (US)

(21) Appl. No.: 13/215,247

(22) Filed: Aug. 23, 2011

(51) Int. Cl. G06F 17/30

(52) U.S. Cl. 707/724; 707/E17.014

(57) ABSTRACT

Aspects of the subject matter described herein relate to geographic searching. In aspects, a search term and a sort indication are received for performing a search. Location information regarding the search is also obtained. If the sort indication indicates that distance is to be used for the search results, a first set of actions is performed that avoids displaying low precision search results; otherwise, a second set of actions is performed that orders search results by a non-distance measure.

### BACKGROUND

People often use search engines to find goods and services in their city or nearby. Sometimes, location information is inaccurate and can lead to problems. For example, when address information is not sufficient, location identifiers on a map may be shown in the wrong location or stacked in a pile in the center of a city. This is confusing and annoying to those using the search engines.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Briefly, aspects of the subject matter described herein relate to geographic searching. In aspects, a search term and a sort indication are received for performing a search. Location information regarding the search is also obtained. If the sort indication indicates that distance is to be used for the search results, a first set of actions is performed that avoids displaying low precision search results; otherwise, a second set of actions is performed that orders search results by a non-distance measure.

### BRIEF DESCRIPTION OF THE DRAWINGS

FIG. 1 is a block diagram representing an exemplary general-purpose computing environment into which aspects of the subject matter described herein may be incorporated;

FIG. 2 is a block diagram that generally represents an exemplary environment in in which aspects of the subject matter described herein may be implemented;

FIG. 3 is a block diagram that generally represents a system configured in accordance with aspects of the subject matter described herein; and

FIGS. 4-5 are flow diagrams that generally represent exemplary actions that may occur in accordance with aspects of the subject matter described herein.

### DETAILED DESCRIPTION

### Definitions

As used herein, the term “includes” and its variants are to be read as open-ended terms that mean “includes, but is not limited to.” The term “or” is to be read as “and/or” unless the context clearly dictates otherwise. The term “based on” is to be read as “based at least in part on.” The terms “one embodiment” and “an embodiment” are to be read as “at least one embodiment.” The term “another embodiment” is to be read as “at least one other embodiment.”

As used herein, terms such as “a,” “an,” and “the” are inclusive of one or more of the indicated item or action. In particular, in the claims a reference to an item generally means at least one such item is present and a reference to an action means at least one instance of the action is performed.

Sometimes herein the terms “first”, “second”, “third” and so forth may be used. Without additional context, the use of these terms in the claims is not intended to imply an ordering but is rather used for identification purposes. For example, the phrase “first version” and “second version” does not necessarily mean that the first version is the very first version or was created before the second version or even that the first version is requested or operated on before the second versions. Rather, these phrases are used to identify different versions.

Headings are for convenience only; information on a given topic may be found outside the section whose heading indicates that topic.

Other definitions, explicit and implicit, may be included below.

### Exemplary Operating Environment

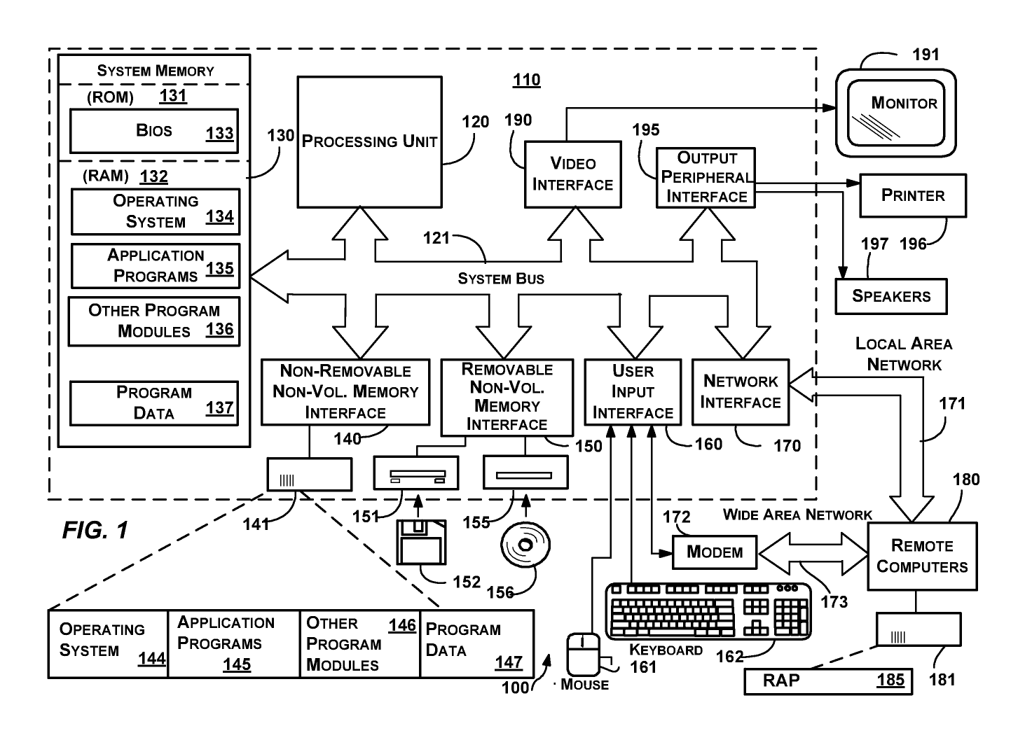

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well-known computing systems, environments, or configurations that may be suitable for use with aspects of the subject matter described herein comprise personal computers, server computers, hand-held or laptop devices, multiprocessor systems, microcontroller-based systems, set-top boxes, programmable consumer electronics, network PCs, minicomputers, mainframe computers, personal digital assistants (PDAs), gaming devices, printers, appliances including set-top, media center, or other appliances, automobile-embedded or attached computing devices, other mobile devices, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. A computer may include any electronic device that is capable of executing an instruction. Components of the computer 110 may include a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, Peripheral Component Interconnect Extended (PCI-X) bus, Advanced Graphics Port (AGP), and PCI express (PCIe).

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media.

Computer storage media includes both volatile and nonvolatile, removable and non-removable media implemented in any method or technology for storage of information such as computer-readable instructions, data structures, program modules, or other data. Computer storage media includes RAM, ROM, EEPROM, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include magnetic tape cassettes, flash memory cards, digital versatile discs, other optical discs, digital video tape, solid state RAM, solid state ROM, and the like. The hard disk drive 141 may be connected to the system bus 121 through the interface 140, and magnetic disk drive 151 and optical disc drive 155 may be connected to the system bus 121 by an interface for removable non-volatile memory such as the interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies.

A user may enter commands and information into the computer 110 through input devices such as a keyboard 162 and pointing device 161, commonly referred to as a mouse, trackball, or touch pad. Other input devices (not shown) may include a microphone, joystick, game pad, satellite dish, scanner, a touch-sensitive screen, a writing tablet, or the like. These and other input devices are often connected to the processing unit 120 through a user input interface 160 that is coupled to the system bus, but may be connected by other interface and bus structures, such as a parallel port, game port or a universal serial bus (USB).

A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets, and the Internet.

When used in a LAN networking environment, the computer 110 is connected to the LAN 171 through a network interface or adapter 170. When used in a WAN networking environment, the computer 110 may include a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Geographic Searching

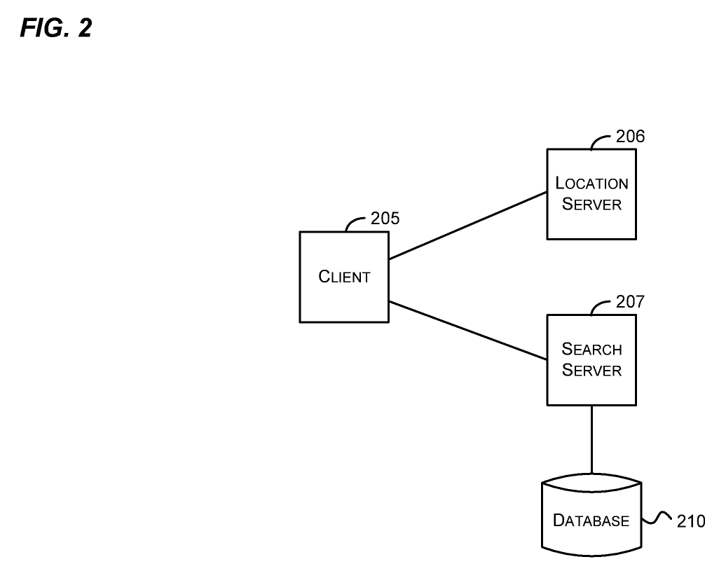

As mentioned previously, users may be confused and annoyed with results returned from search engines. FIG. 2 is a block diagram that represents an exemplary environment in which aspects of the subject matter described herein may be implemented. The components illustrated in FIG. 2 are exemplary and are not meant to be all-inclusive of components that may be needed or included. In other embodiments, the components described in conjunction with FIG. 2 may be included in other components (shown or not shown) or placed in subcomponents without departing from the spirit or scope of aspects of the subject matter described herein.

As used herein, the term component is to be read to include hardware such as all or a portion of a device, a collection of one or more software modules or portions thereof, some combination of one or more software modules or portions thereof and one or more devices or portions thereof, and the like.

Turning to FIG. 2, the environment may include a client 205, a location server 206, a search server 207, and other components (not shown). The various components may be located relatively close to each other (e.g., on the same machine or on machines on the same network) or may be distributed across the world. The various components may communicate with each other via various networks including intra- and inter-office networks.

The client 205, the location server 206, and the search server 207 may comprise or reside on one or more computing devices. Such devices may include, for example, personal computers, server computers, hand-held or laptop devices, multiprocessor systems, microcontroller-based systems, set-top boxes, programmable consumer electronics, network PCs, minicomputers, mainframe computers, cell phones, personal digital assistants (PDAs), gaming devices, printers, appliances including set-top, media center, or other appliances, automobile-embedded or attached computing devices, other mobile devices, distributed computing environments that include any of the above systems or devices, and the like. An exemplary device that may be configured to act as one of the above comprises the computer 110 of FIG. 1.

Although the terms “client” and “server” are sometimes used herein, it is to be understood, that a client may be implemented on a machine that has hardware and/or software that is typically associated with a server and that likewise, a server may be implemented on a machine that has hardware and/or software that is typically associated with a desktop, personal, or mobile computer. Furthermore, a client may at times act as a server and vice versa. At times, two or more entities that more frequently act as a client or server may concurrently be peers, servers, or clients. In an embodiment, a client and server may be implemented on the same physical machine.

Furthermore, as used herein, each of the terms “server” and “client” may refer to one or more physical or virtual entities, one or more processes executing on one or more physical or virtual entities, and the like. Thus, a server may include an actual physical node upon which one or more processes execute, a virtual node upon which one or more processes execute, a service executing on one or more nodes, a group of nodes that together provide a service, and the like. A service may include one or more processes executing on one or more physical or virtual entities. Furthermore, a single process may implement one or more servers.

The term “process” and its variants as used herein may include one or more traditional processes, threads, components, libraries, objects that perform tasks, and the like. A process may be implemented in hardware, software, or a combination of hardware and software. In an embodiment, a process is any mechanism, however called, capable of or used in performing an action. A process may be distributed over multiple devices or located on a single device.

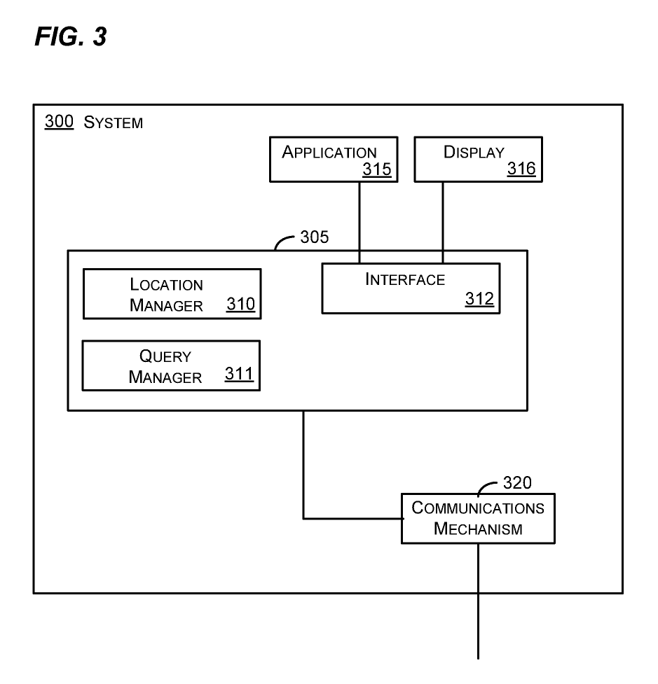

The client 205 may include components for receiving user input, displaying output, interacting with the location server 206 and the search server 207, and the like. Some exemplary components that may be included on the client 205 are described in conjunction with FIG. 3. A user interacting with the client 205 may enter search terms, location information, filter information, and an indication of a desired sort order of results returned by a search. In response, the client 205 may convert the location information using the location server 206 and may formulate a query using the user input for obtaining search results from the search server 207. After receiving the search results, the client 205 may display the search results in a graphical interface in various formats. In one embodiment, the client 205 may provide the search results through another interface such as through sending audio through speakers, providing the results via a braille output device, and the like.

The location server 206 may receive input such as an address, city, or other address information, and may return location information such as one or more coordinates. These coordinates may include latitude, longitude, altitude, or the like. The location server 206 may also return an indication of the precision of the returned location information. For example, when given a full valid address, the location server 206 may return latitude and longitude coordinates that have high precision. As another example, when given an invalid address, a city name without other address information, or an address for a location for which there is not high precision coordinates, the location server 206 may return coordinates with medium, low, or other precision results. For example, if given a city, the location server 206 may return coordinates of a location (e.g., a “center” point) that represents the city. In some embodiments, any location information that is not high precision may be termed as a low precision result even if the location information has more information than just a coordinate representing a city.

In one embodiment, data that indicates whether a location is high precision or low precision may be provided implicitly by indicating a size. For example, this data may indicate a relatively large size for a location that represents a city and a relatively small size for a location that represents a specific address.

In one embodiment, the location server 206 may be implemented as a geocoding server. A geocoding server receives an address and returns one or more coordinates corresponding to the address.

The client 205 may use the returned location information (e.g., one or more coordinates) to formulate a query to provide to the search server 207. The client 205 may also use other user input to formulate the query. For example, a user may indicate that the user wants the results to be sorted by distance. In this example, the client 205 may formulate a query that excludes low precision results and that orders the results by distance from an indicated location. The client 205 may then provide this query to the search server 207, receive results therefrom, and display a graphical representation (e.g., a map, list, or the like), that represents the results.

In another example, the user may indicate that the user wants the results sorted in a non-distance manner. A non-distance sort order is any sort order that orders the results primarily or completely based on something other than distance. Some exemplary not-distance sort orders include relevance, rating, alphabetic, review score, price, and the like. Other non-distance sort orders may also be used without departing from the spirit or scope of aspects of the subject matter described herein.

The search server 207 comprises any server that is capable of returning search results based on a query. A query may include a search term, location information (e.g., a city name, address, coordinates, or other location information), area information around the coordinates (e.g., a radius that defines a circle that is centered at the coordinates, other information that defines an area around the coordinates, or the like), and the like. A search term may include a string, a sound clip (e.g., representing a speech to text conversion), or the like. A string may include one or more characters and zero or more white spaces. A character may include a symbol, number, letter of an alphabet, punctuation, or the like. White space may include one or more characters that represent horizontal or vertical space in typography.

The search server 207 may employ the database 210 in obtaining search results. The database 210 may store data that represents each coordinate of a location and a precision of the location.

The database 210 may comprise a relational database, an object-oriented database, a hierarchical database, a network database, another type of databases, some combination or extension of the above, and the like. Data stored in a database may be organized in tables, records, objects, other data structures, and the like. The data stored in a database may be stored in dedicated database files, dedicated hard drive partitions, HTML files, XML files, spreadsheets, flat files, document files, configuration files, other files, and the like. A database may reference a set of data that is read-only to the database or may have the ability to read and write to the set of data.

Data in a database may be accessed via a database management system (DBMS). A DBMS may comprise one or more programs that control organization, storage, management, and retrieval of data of a database. A DBMS may receive requests to access data in a database and may perform the operations needed to provide this access. Access as used herein may include reading data, writing data, deleting data, updating data, a combination including two or more of the above, and the like.

In describing aspects of the subject matter described herein, for simplicity, terminology associated with relational databases may be used herein. Although relational database terminology may be used herein, the teachings herein may also be applied to other types of databases including those that have been mentioned previously.

FIG. 3 is a block diagram that generally represents a system configured in accordance with aspects of the subject matter described herein. The components illustrated in FIG. 3 are exemplary and are not meant to be all-inclusive of components that may be needed or included. In other embodiments, the components described in conjunction with FIG. 3 may be included in other components (shown or not shown) or placed in subcomponents without departing from the spirit or scope of aspects of the subject matter described herein. In some embodiments, the components and/or functions described in conjunction with FIG. 3 may be distributed across multiple devices.

Turning to FIG. 3, the system 300 may include search components 305, an application 315, a display 316, communication components 320, and other components (not shown). The search components 305 may include a location manager 310, a query manager 311, an interface 312, and other components (not shown). The search components 305 may be hosted on the same device that hosts the application 315 and the display 316 or may be hosted on one or more devices (e.g., a proxy or other component logically between the device and the Internet) other than the device that hosts the application 315 and the display 316.

The system 300 may include one or more computing devices that host the components mentioned above. Such devices may include, for example, personal computers, server computers, hand-held or laptop devices, multiprocessor systems, microcontroller-based systems, set-top boxes, programmable consumer electronics, network PCs, minicomputers, mainframe computers, cell phones, personal digital assistants (PDAs), gaming devices, printers, appliances including set-top, media center, or other appliances, automobile-embedded or attached computing devices, other mobile devices, distributed computing environments that include any of the above systems or devices, and the like.

An exemplary device that may be configured host the components of the system 300 comprises the computer 110 of FIG. 1. In one embodiment, the system 300 may host the client 205 of FIG. 2.

The application 315 may seek to obtain search results from the search components 305. The application 315 may include one or more processes that are capable of communicating with the interface 312. In one embodiment, the application 315 may be implemented as a Web browser and may have components for accessing resources on the Internet. In another embodiment, the application 315 may be implemented as a proprietary search program that includes facilities for receiving search terms, location information, and sort order indications. The application 315 may then provide this data to the interface 312 and may receive search results that are responsive to the search indicated by the data.

The display 316 may be implemented by any device capable of providing output to a user. The monitor 191 of FIG. 1 is one exemplary device, but other output devices including speakers, braille output devices, and the like may also be used without departing from the spirit or scope of aspects of the subject matter described herein.

The communications mechanism 320 allows the search components 305 to communicate with other entities. For example, the communications mechanism 335 may allow the search components to communicate with the location server 206 and the search server 207 of FIG. 2. The communications mechanism 335 may be a network interface or adapter 170, modem 172, USB or other port, or any other mechanism for establishing communications as described in conjunction with FIG. 1.

The interface 312 may be operable to receive a search term and a sort indication of whether distance is to be used for a sort order for ordering search results responsive to the search term. A sort indication may be represented explicitly or implicitly. For example, a sort indication to sort by distance may be indicated explicitly by the presence of a parameter, implicitly by the absence of a parameter, vice versa, or in some other implicit or explicit manner. The interface 312 may receive the search term and sort indication from the application 315. The interface 312 may provide this data to the location manager 310 and the query manager as needed.

In one example, the interface 312 may include a graphical user interface that allows a user to interact with the search components in a graphical manner (e.g., entering search terms in a text box, entering sort order by a drop down box, receiving output via a graphical element, and the like). In one embodiment, the graphical user interface may include a Web browser.

In another example, the interface 312 may include an application programming interface that allows programs that interact with the search components 305.

The interface 312 may also be operable to display search results on the display 316. The interface 312 may use various graphical user elements such as a map element, a list element, a table element, other elements, or the like in displaying search results on the display. In displaying a list or similar structure, the interface 312 may display the search results in an order indicated by the sort order.

The location manager 310 may be operable to obtain location information that indicates a location associated with the search term. For example, referring to FIG. 2, the location manager 310 may be operable to provide an address to the location server 206 and to receive from the location server 206 coordinates for the address. In one implementation, the location manager 310 may send an address to a geocoding server and may receive one or more coordinates from the geocoding server. These coordinates may include, for example, latitude, longitude, and altitude coordinates.

The query manager 311 may be operable to perform a first set of actions if the sort indication indicates that distance is to be used in a sort order for ordering search results responsive to the search term and to perform a second set of actions if the sort indication indicates that distance is not to be used in a sort order for ordering search results responsive to the search term. The first set of actions may include, for example:

1. Creating a query that indicates that data that is associated with high precision location information is to be returned in the search results and that the sort order is by distance from a location indicated by the query;

2. Providing the query to a search server (e.g., the search server 207 of FIG. 2); and

3. Receiving, from the search server, a response that includes the search results. The search results included in the response are ordered by the sort order (i.e. distance) indicated by the query.

The second set of actions may include, for example:

1. Creating a query that indicates that data that is associated with any precision is to be returned in the search results. The query may also indicate that the sort order for the search results is an order other than distance from the location. The indications above may be provided implicitly or explicitly in a manner similar to indicating a sort indication as described previously;

2. Providing the query to the search server (e.g., the search server 207 of FIG. 2); and

3. Receiving a response that includes the search results from the search engine. The search results are ordered by the sort order (i.e., non-distance) indicated by the query.

When providing results on a map, the query manager 311 may be further operable to refrain from providing low precision locations to the interface 312. When results are to be provided to a map, the sort indication may indicate that distance is to be used in the sort order for ordering search results. In this case, low precision locations may be confusing or annoying to a user and can be omitted by the query manager 311 to improve the displayed search results.

In addition, the query manager 311 may be further operable to provide a single result for a company to the interface 312 if the company has multiple locations. This may also help to avoid confusing or annoying a user and to avoid redundancy, for example.

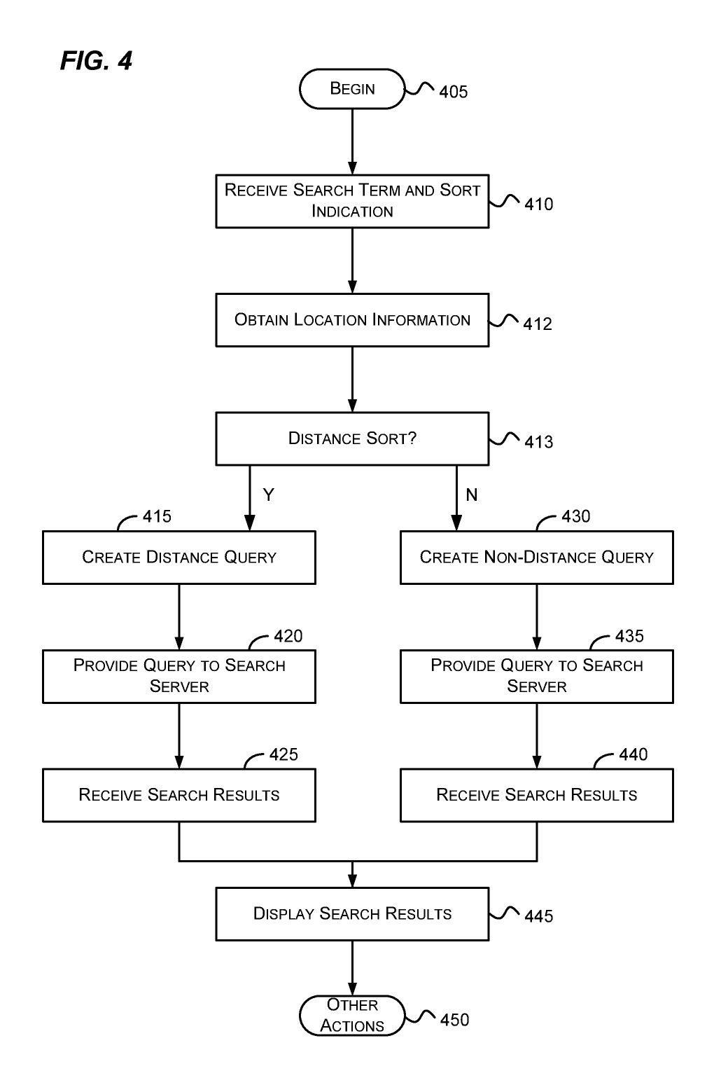

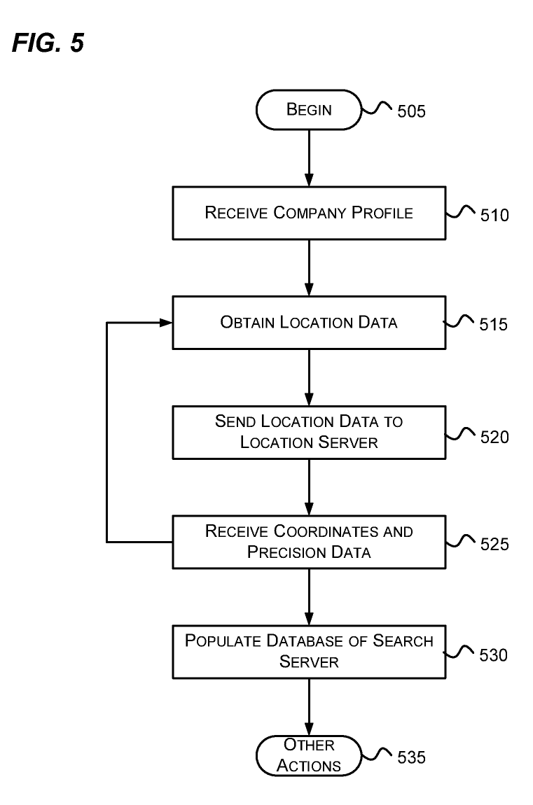

FIGS. 4-5 are flow diagrams that generally represent exemplary actions that may occur in accordance with aspects of the subject matter described herein. For simplicity of explanation, the methodology described in conjunction with FIGS. 4-5 is depicted and described as a series of acts. It is to be understood and appreciated that aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events.

Turning to FIG. 4, at block 405, the actions begin. At block 410, a search term and sort indication may be received. For example, referring to FIG. 3, a user may enter the term “database” into a text box displayed on the display 316. The user may also indicate that the sort order is to be by distance in a drop down list box displayed on the display 316.

At block 412, location information is obtained. For example, referring to FIG. 3, a user may enter a location such as “Seattle” into a text box displayed on the display 316. As another example, a user may enter coordinates into the text box. In one implementation, this location information may be associated with the search term by virtue of being entered on the same screen as the search term. In another implementation, location information may be inferred by IP address, data stored on the computer, global positioning system (GPS) data, or otherwise. This location information may be received by the location manager 310. If the location is not in coordinate form, the location manager 310 may obtain location information in the form of coordinates form the location server 206. In one embodiment, obtaining location information may include sending, to a geocoding server, a description (e.g., address, name of city, or other description) associated with the location and, in response, receiving one or more coordinates that indicate one or more of latitude, longitude, and altitude.

At block 413, a determination is made as to whether the sort indication indicates that a distance is to be used in the sort order. If so, the actions associated with blocks 415-425 may be performed; otherwise, the actions associated with blocks 430-440 may be performed.

At block 415, a distance query is created. For example, referring to FIG. 3, the query manager 311 may create a distance query. A distance query may instruct a search engine to omit low precision results from the search results and that the sort order is to be by distance from a location included in the query.

At block 420, the query is provided to the search server. For example, referring to FIG. 2, the client 205 provides the query to the search server 207.

At block 425, search results are received. For example, referring to FIG. 2, the client 205 receives from the search server 207 a response that includes the search results. Receiving a response from the search server 207 does not necessarily mean that the search server 207 provides all of the search results in a single response. Indeed, the search server 207 most often will provide a small subset (e.g., a page) of the total search results in the response and may provide additional subsets (e.g., additional pages) of the total search results as a navigates through the search results.

At block 430, a non-distance query is created. For example, referring to FIG. 3, the query manager 311 may create a non-distance query. As indicated earlier, a non-distance query is a query that is sorted by a measure other than distance. A non-distance query may use distance to include/exclude possible search results. For example, a user wanting to know all grocery stores within Seattle will not be given grocery stores in New York. As indicated earlier, some exemplary non-distance measures include: relevance, rating, alphabetic, review score, price, and the like.

At block 435, the query is provided to the search server. For example, referring to FIG. 2, the client 205 provides the query to the search server 207.

At block 440, search results are received. For example, referring to FIG. 2, the client 205 receives from the search server 207 a response that includes the search results.

At block 445, the search results may be displayed. For example, referring to FIG. 3, the search results may be displayed on the display 316. When the sort order is by distance, a query manager may refrain from displaying in a map a graphical representation (e.g., a thumb tack) for low precision locations. To determine whether a low precision location is included in the search results, the query manager may compare locations included in the search result with previously known low precision locations. For example, each time a location server provides coordinates and a precision associated with the location, a location manager may store this information and precision.

At block 450, other actions, if any, may be performed.

Turning to FIG. 5, at block 505, the actions begin. At block 510, a searchable data that indicates one or more locations is received. For example, referring to FIG. 2, the client 205 may receive a company profile. A company profile may include one or more locations of company offices, name of the company, and other company data, for example.

At block 515, location data is obtained from the one or more locations indicated in the searchable data. For example, referring to FIG. 2, the client 205 may retrieve the location data from a company profile. Obtaining location data may include obtaining one or more street or other addresses associated with the company profile.

At block 520, the location data is sent to a location server. For example, referring to FIG. 2, the client 205 may send the location data to the location server 206. Sending the location data to a location server may include for each of the one or more street addresses, sending data representing the street address to a geocoding server and, in response, receiving one or more coordinates that represent latitude, longitude, and/or altitude.

At block 525, coordinates and precision data are received from the location server. For example, referring to FIG. 2, the client 205 may receive the coordinates and precision data from the locations server 206. The precision data may indicate precision of the coordinates for each location.

The actions associated with blocks 520-525 may be omitted if the location data obtained at block 515 already contains coordinates or other location information sufficient to perform the actions of blocks 530-535.

At block 530, a database of a search server is populated with the precision data such that each coordinate of a location is associated with a precision of the location. For example, referring to FIG. 2, the client 205 may send the precision data and coordinates to the search server 207 to populate a database of the search server 207. The search server 207 may associate precision data with coordinates for subsequent use.

At block 535, other actions if any, may be performed. Other actions may include grouping coordinates and precision by company. Other actions may also include grouping high precision coordinates together and non-high precision coordinates together.

In one embodiment, the term “company” as used herein means any real-world entity and may include a person, a legal entity including profit and non-profit organizations, an organization, an association, or the like. In another embodiment, the term “company” as used herein means a virtual or other non real-world entity. Software is one example of a virtual entity that may be represented by code on a physical device. In the claims, the term company is to be construed to cover both of the embodiments above unless the context indicates otherwise.

As can be seen from the foregoing detailed description, aspects have been described related to geographic searching. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A method implemented at least in part by a computer, the method comprising:
receiving a search term and a sort indication of whether distance is to be used for a sort order for ordering search results responsive to the search term;
obtaining location information that indicates a location associated with the search term;
if the sort indication indicates that distance is to be used in a sort order for ordering search results responsive to the search term, performing a first set of actions, the first set of actions comprising:
creating a first query that indicates that data that is associated with high precision location information is to be returned in the search results and that the sort order is by distance from the location,
providing the first query to a search server, and
receiving, from the search server, a response that includes the search results, the search results ordered by the sort order; and
if the sort indication indicates that distance is not to be used in a sort order for ordering search results responsive to the search term, performing a second set of actions, the section set of actions comprising:
creating a second query that indicates that data that is associated with any precision is to be returned in the search results and that indicates that the sort order is an order other than distance from the location,
providing the second query to the search server, and
receiving a response that includes the search results from the search engine, the search results ordered by the sort order.

2. The method of claim 1, wherein receiving a search term comprises receiving a string that includes zero or more characters and zero or more white spaces.

3. The method of claim 1, wherein obtaining location information that indicates a location associated with the search term comprises sending, to a geocoding server, a description associated with the location and, in response, receiving one or more coordinates that indicate one or more of latitude, longitude, and altitude.

4. The method of claim 1, wherein receiving an indication of whether distance is to be used for a sort order for ordering search results responsive to the search term, comprises receiving data that indicates one of: distance, relevance, rating, alphabetic, review score, and price.

5. The method of claim 1, wherein the first set of actions, further comprises determining whether a low precision location is included in the search results, and if so, refraining from displaying, in a map, a graphical representation for the low precision location.

6. The method of claim 5, wherein determining whether a low precision location is included in the search results comprises comparing each location included in the search results with previously known low precision locations.

7. The method of claim 1, wherein the second set of actions further comprises displaying the search results ordered by the sort order in a graphical element of a graphical user interface.

8. A computer storage medium having computer-executable instructions, which when executed perform actions, comprising:
receiving searchable data that indicates one or more locations;
obtaining location data for at least one of the one or more locations from the searchable data;
sending the location data to a location server;
receiving coordinates from the location server and precision data that indicates precisions of the coordinates;
populating a database of a search server with the precision data such that each coordinate of a location is associated with a precision of the location.

9. The computer storage medium of claim 8, wherein obtaining location data for at least one of the one or more locations from the searchable data comprises obtaining one or more street addresses associated with a company profile.

10. The computer storage medium of claim 9, wherein sending the location data to a location server comprises, for each of the one or more street addresses, sending data representing the street address to a geocoding server and, in response, receiving one or more coordinates that represent latitude, longitude, and/or altitude.

11. The computer storage medium of claim 8, further comprising grouping coordinates and precision by company.

12. The computer storage medium of claim 8, further comprising grouping high precision coordinates of the one or more locations in a first group and grouping other precision coordinates of the one or more locations in a second group.

13. In a computing environment, a system, comprising:
an interface operable to receive a search term and a sort indication of whether distance is to be used for a sort order for ordering search results responsive to the search term;
a location manager operable to obtain location information that indicates a location associated with the search term; and
a query manager operable to perform a first set of actions if the sort indication indicates that distance is to be used in a sort order for ordering search results responsive to the search term and to perform a second set of actions if the sort indication indicates that distance is not to be used in a sort order for ordering search results responsive to the search term,
the first set of actions, comprising:
creating a first query that indicates that data that is associated with high precision location information is to be returned in the search results and that the sort order is by distance from the location,
providing the first query to a search server, and
receiving, from the search server, a response that includes the search results, the search results ordered by the sort order;
the second set of actions, comprising:
creating a second query that indicates that data that is associated with any precision is to be returned in the search results and that indicates that the sort order is an order other than distance from the location,
providing the second query to the search server, and
receiving a response that includes the search results from the search engine, the search results ordered by the sort order.

14. The system of claim 13, wherein the interface comprises a graphical interface.

15. The system of claim 13, wherein the graphical interface comprises a Web browser.

16. The system of claim 13, wherein the interface comprises an application programming interface.

17. The system of claim 13, wherein the location manager being operable to obtain location information that indicates a location associated with the search term comprises the location manager being operable to send, to a geocoding server, an address associated with the location and, in response, to receive one or more coordinates that indicate one or more of latitude, longitude, and altitude.

18. The system of claim 13, wherein the interface is further operable to display the search results ordered by the sort order.

19. The system of claim 18, wherein the query manager is further operable for perform additional actions comprising refraining from providing low precision locations to the interface for display if the sort indication indicates that distance is to be used in a sort order for ordering search results responsive to the search term.

20. The system of claim 13, wherein the query manager is further operable to provide a single result for a company to the interface for display even if the company has multiple locations.
